(19) United States
(12) Patent Application Publication
(10) Pub. No.: US 2007/0162253 A1
(43) Pub. Date: Jul. 12, 2007

(54) QUILTING AND SEWING CALCULATOR

(76) Inventors: Susan Blades, Carson City, NV (US); Michael Diamond, Carson City, NV (US)

Correspondence Address: IAN F. BURNS & ASSOCIATES, P.O. BOX 71115, RENO, NV, 89570, US

(21) Appl. No.: 11/610,812

(22) Filed: Dec. 14, 2006

Related U.S. Application Data
(60) Provisional application No. 60/758,428, filed on Jan. 11, 2006.

(51) Int. Cl. G06F 15/00

(52) U.S. Cl. 702/155; 702/127; 702/156; 702/158

(57) ABSTRACT

The present invention comprises a calculator for performing sewing calculations. The calculator includes a processor and an input device connected to the processor. A display is connected to the processor. Software operates on the processor to receive quilt function operands from the input device. The software calculates quilt function results and displays the quilt function results on the display. A method of performing calculations is also disclosed. The method includes receiving data related to quilt calculations. The results related to the quilt calculations are calculated and the results related to the quilt calculations are displayed.

### BACKGROUND

1. Field of the Invention

The present invention relates to calculators. More particularly, the present invention relates to calculators especially adapted to perform calculations and conversions of data related to sewing and fabric, including the production of quilts, blankets and the like.

2. Description of the Related Art

Many handheld portable calculators have been developed to perform general purpose calculations. Calculators have also been developed to perform application specific calculations. For example, there are calculators for performing mortgage calculations and construction project calculations. One such specialty calculator is shown in U.S. Pat. No. 6,721,623 to Diamond et. al and is titled, “Woodworking and Home Improvement Calculator”.

The making of quilts is a popular craft activity and hobby for individuals. The manufacture of a quilt includes designing and cutting various shapes and sizes of material and sewing them together. The calculation of the amount of material needed and the size of the pieces to cut for a quilt is not a trivial matter. Accurate calculation of fabric sizes and shapes, including blocks, squares, triangles, borders, sashes, backings and bindings, and costs and other quilt parameters involves numerous mathematical steps that can be complex.

A current unmet need exists for a handheld portable calculator that can perform quilt and fabric related calculations.

### SUMMARY

Advantages of One or More Embodiments of the Present Invention

The various embodiments of the present invention may, but do not necessarily, achieve one or more of the following advantages:

the ability to calculate the amount of fabric needed to produce a quilt;

the ability to calculate the cost of materials needed for a quilt;

the ability to calculate various quilt dimensions, areas and parameters;

provide an apparatus that can calculate various quilt parameters;

provide a calculator that can accept quilt function operands as an input;

provide a calculator that can display quilt and fabric functions and dimensions;

provide a calculator that can be used with different measurement units and systems;

provide a calculator that can calculate the dimensions of material to be cut;

These and other advantages may be realized by reference to the remaining portions of the specification, claims, and abstract.

### BRIEF DESCRIPTION

The present invention comprises a calculator for performing quilt calculations. The calculator includes a processor and an input device connected to the processor. A display is connected to the processor. Software operates on the processor to receive at least one quilt function operand from the input device. The software calculates at least one quilt function result and displays the quilt function result on the display.

The present invention further comprises a method of performing calculations. The method includes receiving data related to at least one quilt calculation. The results related to the at least one quilt calculation are calculated and the results related to the at least one quilt calculation are displayed.

The above description sets forth, rather broadly, a summary of one embodiment of the present invention so that the detailed description that follows may be better understood and contributions of the present invention to the art may be better appreciated. Some of the embodiments of the present invention may not include all of the features or characteristics listed in the above summary. There are, of course, additional features of the invention that will be described below and will form the subject matter of claims. In this respect, before explaining at least one embodiment of the invention in detail, it is to be understood that the invention is not limited in its application to the details of the construction and to the arrangement of the components set forth in the following description or as illustrated in the drawings. The invention is capable of other embodiments and of being practiced and carried out in various ways. Also, it is to be understood that the phraseology and terminology employed herein are for the purpose of description and should not be regarded as limiting.

### BRIEF DESCRIPTION OF THE DRAWINGS

The embodiments of the present invention are shown in the drawings, wherein:

FIG. 1 is substantially a top view of a quilt.

FIG. 2 is substantially a top view of an embodiment of a quilt and fabric calculator in accordance with the present invention.

FIG. 3 is substantially an enlarged top view of the display shown in FIG. 2.

FIG. 4 is substantially a schematic diagram of internal components of the calculator of the present invention

FIGS. 5A and 5B are substantially a flowchart of a method of performing quilt function calculations related to quilt area in accordance with the present invention.

FIG. 6 is substantially a flowchart of a method of performing quilt function calculations related to quilt diagonal in accordance with the present invention.

FIGS. 7A and 7B are substantially a flowchart of a method of performing quilt function calculations related to blocks and sashes in accordance with the present invention.

FIG. 8A is substantially a flowchart of a method of performing quilt function calculations related to squares in accordance with the present invention.

FIG. 8B is substantially a flowchart of a method of performing quilt function calculations related to triangles in accordance with the present invention.

FIG. 8C is substantially a flowchart of a method of performing quilt function calculations related to diamonds in accordance with the present invention.

FIG. 9 is substantially a flowchart of a method of performing quilt function calculations related to when a known amount of fabric (stash) is known.

FIG. 10 is substantially a flowchart of a method of calculating the cost of fabric.

### DESCRIPTION OF THE EMBODIMENTS

In the following detailed description of the embodiments, reference is made to the accompanying drawings, which form a part of this application. The drawings show, by way of illustration, specific embodiments in which the invention may be practiced. It is to be understood that other embodiments may be utilized and structural changes may be made without departing from the scope of the present invention.

Quilt

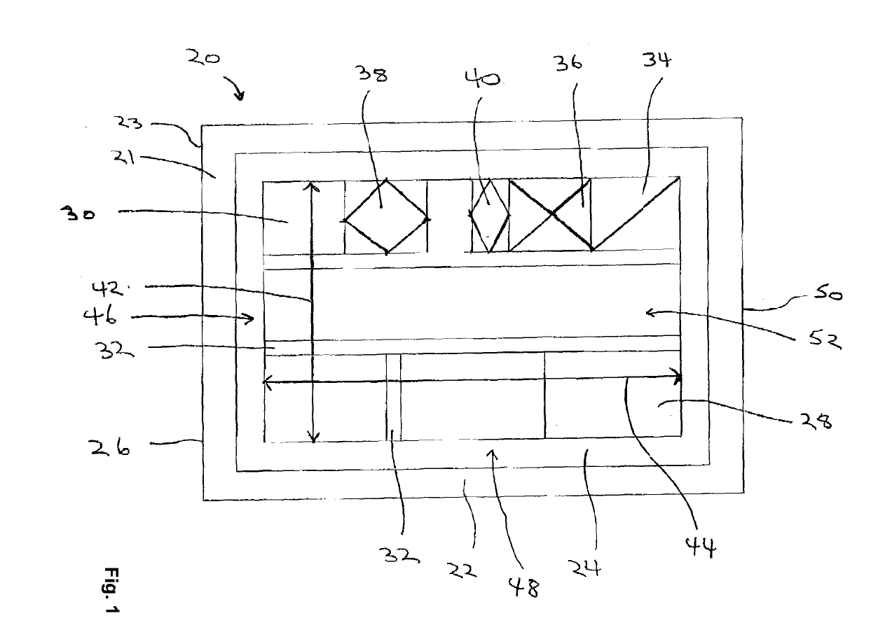

Referring to FIG. 1, an example of a typical quilt 20 is shown. Quilt 20 has various sections, pieces, features and components. Quilt 20 can include a wide variety of designs that are made from a wide variety of fabrics and materials. Quilt 20 can include a top surface 21 and a bottom surface 23. A drop section 22 can be placed around the perimeter of the quilt. Border 24 can outline the interior area of the quilt. Binding 26 seals the raw edges of the fabric and batting. Quilt 20 can include pieces with various shapes, such as block 28, square 30, ½ square triangle 34, ¼ square triangle 36, 45° diamond 38 and 60° diamond 40.

Quilt 20 has a top width 42, a top height 44, a number of blocks across 46 and a number of blocks down 48. Backing 50 is a fabric layer that covers the back of the quilt. Batting 52 is a layer that is located between the quilt top and the back, which provides the loft and insulation. Quilt 20 may include a sash 32 that is located between the blocks or squares.

Quilt 20 can include all of the sections, pieces, features and components. Alternatively, several of the pieces and components can be omitted. For example, sash 32 and the triangles 34 or 36 could be omitted from the quilt design.

Calculator

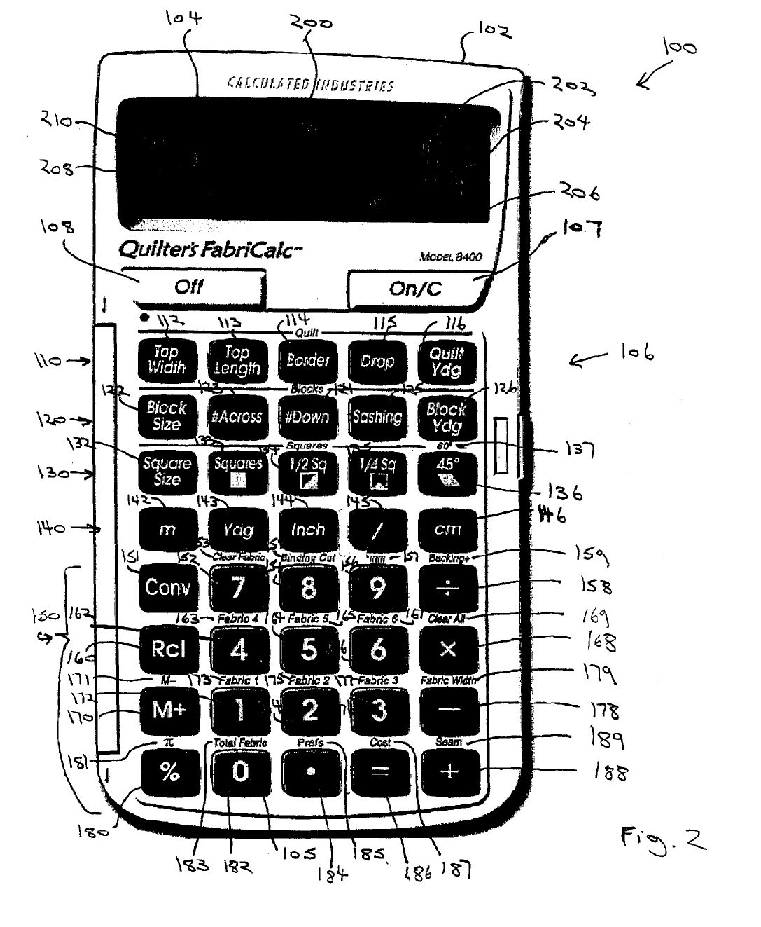

Referring to FIG. 2 a calculator 100 for performing quilt and fabric calculations is shown. Calculator 100 can have a housing 102. Housing 102 can be formed from a material such as plastic. Housing 102 includes a display opening 104 and keyholes 105. Several keys 106 extend through keyholes 105. Keys 106 can include an on key 107 and an off key 108 for turning the calculator on and off. Pressing the on key once clears the display. Pressing the on key twice clears all temporary stored values.

The calculator includes circuitry responsive to the keys 106 for receiving input and performing calculations. The input value is displayed on the display 200; and the results of all calculations are also displayed on the display 200. The software for implementing the function of the calculator can be programmed from the flowcharts and formulas that will be further described below.

The calculator is “key driven”, meaning that the internal operation of the calculator is dependent upon the last key entered. Major branching decisions within the software are made on the basis of the most recent key entry. In addition to the quilt specific functions and calculations performed by calculator 100, calculator 100 can also perform standard mathematical operations.

Calculator 100 can also have a row of quilt keys 110 that are located below the on and off keys. The quilt keys are used to input quilt function operands and to obtain quilt function results on calculator 100. Quilt key row 110 can include a top width key 112, a top length key 113, a border key 114, a drop key 115 and a quilt ydg key 1 16.

The top width key 112 is used for entering the finished width of the quilt top. The top length key 113 is used for entering the finished length of the quilt top. Pressing the top length key a second time calculates and displays the diagonal length of the quilt. The border key 114 is used for entering the finished border width. Consecutive presses of the border key results in the calculation and display of border yardage, number of border strips and border strip cut width. The drop key 115 is used for entering the finished drop width. Consecutive presses of the drop key results in the calculation and display of drop yardage, number of drop strips and drop strip cut width.

The quilt ydg or yardage key 116 is used to calculate several quilt function results. Consecutive presses of the quilt yardage key results in the calculation and display of top quilt yardage, backing yardage, border yardage, number of border strips, border strip cut width, number of drop strips, drop strip cut width, binding yardage, number of binding strips and binding strip cut width.

A block key row 120 is located below the quilt key row 1 10. The block keys are used to input quilt function operands related to blocks and to obtain quilt function results on calculator 100. Block key row 120 can include a block size key 122, a number across key 123, a number down key 124, a sashing key 125 and a block ydg key 126.

The block size key 122 is used for entering the block width. Pressing the conv key 151 and the block size key 122 enters the block height. If no block height is entered, the block is assumed to be square. The # across key 123 is used for entering the number of blocks across the width of the quilt. The # down key 124 is used for entering the number of blocks down the length of the quilt. The sashing key 125 is used for entering the finished sashing width. Consecutive presses of the sashing key results in the calculation and display of sashing yardage, number of sashing strips and sashing strip cut width.

The block ydg or yardage key 126 is used to calculate several quilt function results. Consecutive presses of the block yardage key results in the calculation and display of total block yardage, number of blocks, number of block strips, block cut width, sashing yardage, number of sashing strips and sashing strip cut width.

A square key row 130 is located below the block key row 120. The square keys are used to input quilt function operands related to squares and triangles and to obtain quilt function results on calculator 100. Square key row 130 can include a square size key 132, squares key 133, a ½ square triangle key 134, a ¼ square triangle key 135 and a 45° diamond key 136. The 60° diamond key 137 can be accessed by pressing the conv key 151, then pressing key 136.

The square size key 132 is used for entering the square width and length. Pressing the square size key 132 a second time displays the diagonal of the square. The squares key 133 is used to enter the number of squares. Consecutive presses of the squares key 133 results in the calculation and display of total square yardage, number of square strips and square strip cut width. The squares key 133 can also be used to calculate the number of squares that can be produced from a known fabric area after the fabric area has been entered. The squares key 133 can also be used to calculate the optimum or maximum number of squares strips that can be produced from a known fabric area after the fabric width and square size has been entered.

The ½ square triangles key 134 is used to enter the number of ½ square triangles. Consecutive presses of the ½ square triangles key 134 results in the calculation and display of total yardage, number of ½ square triangle strips and ½ square triangle strip cut width. The ½ square triangles key 134 can also be used to calculate the number of ½ square triangles that can be produced from a known fabric area after the fabric area has been entered. The ½ square triangles key 134 can also be used to calculate the optimum or maximum number of ½ square triangle strips that can be produced from a known fabric area after the fabric width and ½ square triangle size has been entered.

The ¼ square triangles key 135 is used to enter the number of ¼ square triangles. Consecutive presses of the ¼ square triangles key 135 results in the calculation and display of total yardage, number of ¼ square triangle strips and ¼ square triangle strip cut width. The ¼ square triangles key 135can also be used to calculate the number of ¼ square triangles that can be produced from a known fabric area after the fabric area has been entered. The ¼ square triangles key 135 can also be used to calculate the optimum or maximum number of ¼ square triangle strips that can be produced from a known fabric area after the fabric width and ¼ square triangle size has been entered.

The 45° diamond key 136 is used to enter the number of 45° diamonds. Consecutive presses of the 45° diamond key 136 results in the calculation and display of total yardage, number of 45° diamond strips, 45° diamond strip cut width and 45° diamond cut length. The 45° diamond key 136 can also be used to calculate the number of 45° diamonds that can be produced from a known fabric area after the fabric area has been entered. The 45° diamond key 136 can also be used to calculate the optimum or maximum number of 45° diamond strips that can be produced from a known fabric area after the fabric width and 45° diamond size has been entered.

The 60° diamond key 137 is used to enter the number of 60° diamonds. Consecutive presses of the 60° diamond key 137 results in the calculation and display of total yardage, number of 60° diamond strips, 60° diamond strip cut width and 60° diamond cut length. The 60° diamond key 137 can also be used to calculate the number of 60° diamonds that can be produced from a known fabric area after the fabric area has been entered. The 60° diamond key 137 can also be used to calculate the optimum or maximum number of 60° diamond strips that can be produced from a known fabric area after the fabric width and 60° diamond size has been entered.

A unit key row 140 is located below the square key row 130. The unit keys are used to input dimensional and fractional unit data and perform conversions between English and Metric units. The default units are English. Unit key row 140 can include a meterage key 142, a yardage key 143, an inch key 144, a fraction key 145 and a centimeter key 146.

A square yard is 1 yard long by 1 yard wide. However, fabric is sold in the United States in Yardage which is 1 yard long by the width of the fabric which is typically 40 to 42 inches wide. In other countries, fabric is sold in Meterage which is 1 meter long by the width of the fabric which is typically around 104 centimeters wide.

The meterage key 142 is used for entering or converting to square meters. The meterage value is based upon the stored fabric width. The yardage key 143 is used for entering or converting to square yards. The yardage value is based upon the stored fabric width. The default fabric width is 40 inches, which is the width of a standard bolt of fabric. Calculator 100 automatically rounds Yardage values up to the nearest ⅛ yard increment. Fabric is typically sold in ⅛ yard increments, therefore any partial yardages must be rounded up to the nearest ⅛ yard increment.

Therefore, the calculator 100 of the present invention is able to perform quilting and sewing calculations using both of the units or values, Yardages and Meterages, that fabric is commonly sold in.

Numeric keys 150 are located below the unit key row 140. The numeric keys are used to input numerical information and perform mathematical calculations. Numeric keys 150 can include a conversion key 151, a seven key 152, an eight key 154, a nine key 156, a division key 158, a recall key 160, a four key 162, a five key 164, a six key 166, a multiplication key 168, a memory input key 170, a one key 172, a two key 174, a three key 176, a subtraction key 178, a percent key 180, a zero key 182, a decimal point key 184, an equal sign key 186 and an addition key 188. The numeric keys 150 function the same as a conventional calculator and allow for the mathematical functions of addition, subtraction, multiplication and division to be performed. The recall key 160 recalls the value stored in the memory register. The memory input key 170 stores values in the memory register. The conversion key 151 is used to convert between fractions and decimals and is used to convert between English and metric systems. The conversion key 151 is also used to access the secondary functions.

Various keys or quilt functions can be input and accessed by using the conv key 151 in conjunction with numeric keys 150. Each of the keys or functions accessed using the conv key 151 is written above keys 150.

A clear fabric key 153 is accessed by pressing key 151 and key 152 in sequence. The clear fabric key clears all values from the fabric storage registers. A binding cut key 155 is accessed by pressing key 151 and key 154 in sequence. The binding cut key stores the binding cut width. The default value is 2.5 inches. The binding cut width is used with the binding calculation.

A millimeter key 157 is accessed by pressing key 151 and key 156 in sequence. The millimeter key is used to enter or convert to millimeters. A backing+key 159 is accessed by pressing key 151 and key 158 in sequence. The backing+key stores the backing overage value. The default value is 4.0 inches. The backing overage value is used with the backing calculation. The backing overage is added to all sides to accommodate the extra material needed during the quilting processes.

The fabric storage keys 163, 165, 167, 173, 175 and 177 are accessed by pressing key 151 in combination with one of keys 162, 164, 166, 172, 174, or 176, respectively. The fabric storage keys are used to store various fabric yardages. Up to six different types of fabric areas or yardages can be stored.

The clear all key 169 is accessed by pressing key 151 and key 168 in sequence. The clear all key clears all stored values from all registers.

A memory—key 171 is accessed by pressing key 151 and key 170 in sequence. The memory—key subtracts the displayed value from the cumulative value stored in memory.

A fabric width key 179 is accessed by pressing key 151 and key 178 in sequence. The fabric width key stores the fabric width. The default value is 40 inches. The fabric width is used in all material calculations. Calculator 100 can accept variable fabric widths using fabric width key 179.

The pi key 155 is accessed by pressing key 151 and key 180 in sequence. The pi key 155 has a value of 3.14. A total fabric key 183 is accessed by pressing key 151 and key 182 in sequence. The total fabric key displays the total sum of all the values of fabric yardages that are stored in the six fabric storage registers.

A preferences key 185 is accessed by pressing key 151 and key 184 in sequence. Preferences key 185 is used to enter the default settings for the corner type (miter or straight), sashing (included/excluded) and measurement system (English/metric).

A cost key 187 is accessed by pressing key 151 and key 186 in sequence. Cost key 187 is used to enter the price per square yard of material which is used in the cost calculation. A seam key 189 is accessed by pressing key 151 and key 188 in sequence. Seam key 189 is used to enter the seam width. The default seam width is ¼ inch. This value is used in the material calculations.

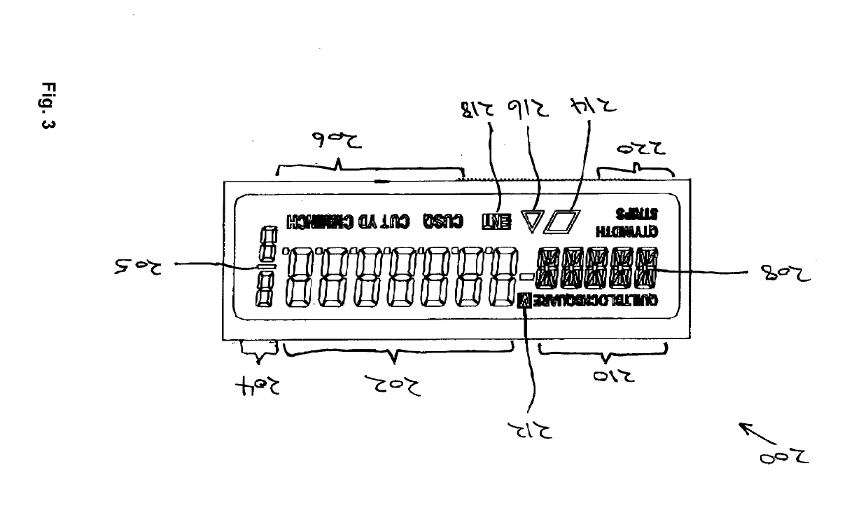

With reference now to FIG. 3, calculator 100 can have a display 200. Display 200 can be a wide variety of different types of displays. For example, display 200 can be a liquid crystal display or can be an light emitting diode display or can be an electro-luminescent display.

Display 200 can include a 7 segment whole and decimal display 202 and a fractions display 204 that has a single segment numerator, a single segment denominator and a slash 205. The units measurement display 206 can display measurement units such as CU, SQ, CUT, YD, CM, MM, M and INCH. A five segment alpha-numeric display 208 can show various words and abbreviations. Quilt function display 210 can display quilt functions such as QUILT, BLOCK and SQUARE.

Memory indicator 212 indicates that a value is stored in the memory register. Diamond symbol 214 is used to indicate that the display contents pertain to diamonds. Triangle symbol 216 is used to indicate that the display contents pertain to triangles. Enter symbol 218 indicates when the calculator user is being prompted to enter and input value. Quilt annuciator display 220 can select from the words QTY, WIDTH and STRIPS to display.

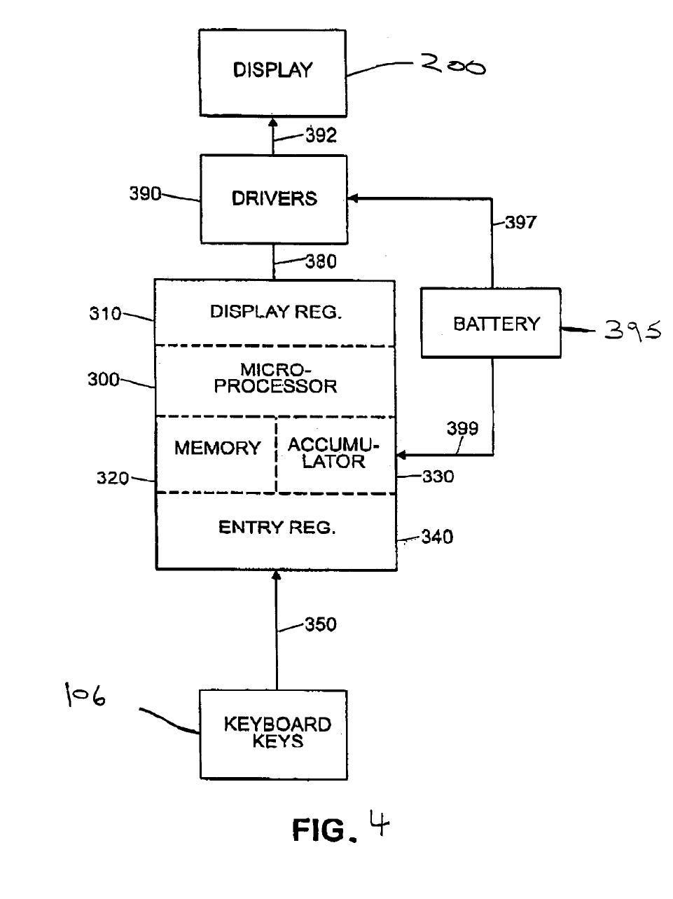

Turning now to FIG. 4, a schematic diagram of calculator 100 is shown. Calculator 100 can include a conventional microprocessor 300 that contains a display register 310, a memory 320, an accumulator 330, and an entry register 340. The microprocessor 300 is interconnected over bus 350 to the keys 106. The microprocessor 300 communicates over bus 380 with drivers 390. The drivers 390 communicate over bus 392 with the display circuit 14. A battery power supply 395 provides power over lines 397 and 399 to the drivers 390 and to the microprocessor 300 respectively. Calculator 100 can be configured by one skilled in the art will using commercially available components.

Software can be stored in memory 320 that can operate on microprocessor 300 to perform the quilt related functions and calculations of the present invention. The software can receive quilt related operands from keys 106, calculate quilt function results and cause display 200 to display the quilt function results.

Operation

The present invention further comprises a method of inputting quilt function operands and calculating quilt function results.

Quilt Area Functions and Related Calculations

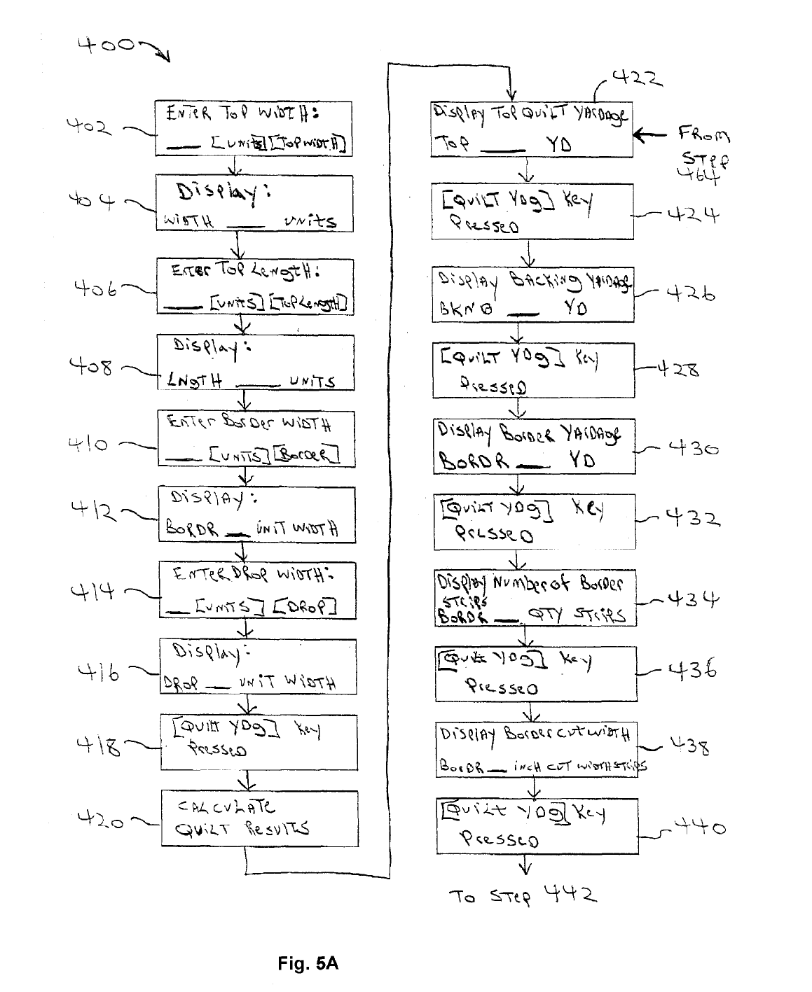

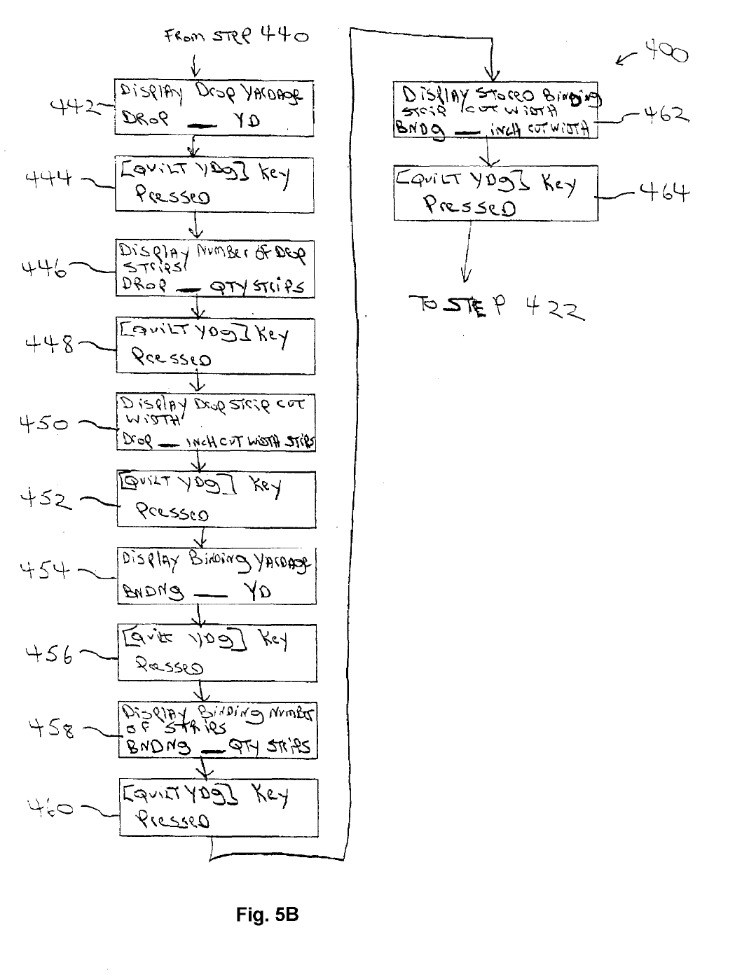

Referring to FIGS. 5A and 5B, a flowchart 400 that details the calculator operation and software program flow to determine and display quilt area and related quilt function calculations is shown. First, a user enters a top width at step 402. Inches is the default value for units. The default value can be set to other units such as meters. The display confirms the entered value at step 404 by displaying “WIDTH” in the alpha-numeric display 208 and the appropriate value in the numeric displays 202 and 204. The appropriate units are displayed on units measurement display 206. Next, the top length is entered at step 406. The display confirms the entered value at step 408 by displaying “LNGTH” in the alpha-numeric display and the appropriate value in the numeric displays. The border width is entered at step 410. The display confirms the entered value at step 412 by displaying “BORDR” in the alpha-numeric display and the appropriate value in the numeric displays. The drop width is entered at step 414. The display confirms the entered value at step 416 by displaying “DROP” in the alpha-numeric display and the appropriate value in the numeric displays.

At step 418, the [Quilt Ydg] key 116 is depressed and all relevant calculations are performed at step 420. The top quilt area or yardage is displayed at step 422 by displaying “TOP” in the alpha-numeric display and the appropriate value in the numeric displays.

The following formulas are used to calculate the quilt area:

TotalLength=TopLength+Drop+2 Border

TotalWidth=Top Width+2 Drop+2 Border

TotalQuiltYardage=(TopLength*RoundUp(Top Width/(Fabric Width−2*Seam)

It is noted that the calculator may use the linear or running method to calculate the values for top quilt yardage and backing yardage.

Subsequent depression of the [Quilt Ydg] key 116 at step 424 causes the backing area or yardage to be displayed at step 426 by displaying “BKNG” in the alpha-numeric display and the appropriate value in the numeric displays.

The following formulas are used to calculate the backing yardage:

TotalBacking Yardage=(TotalLength+2*Backing)*RoundUp((TotalWidth+2*Backing)/(Fabric Width−2*Seam))

Subsequent depression of the [Quilt Ydg] key 116 at step 428 causes the border area or yardage to be displayed at step 430 by displaying “BORDR” in the alpha-numeric display and the appropriate value in the numeric displays.

Subsequent depression of the [Quilt Ydg] key 116 at step 432 causes the number of border strips to be displayed at step 434 by displaying “BORDR” in the alpha-numeric display, the appropriate value in the numeric displays and “QTY” in annunciator display 220. Depressing the [Quilt Ydg] key 116 again at step 436 causes the border cut width to displayed at step 438 by displaying “BORDR” in the alpha-numeric display, the appropriate value in the numeric displays ,“Cut” in the units measurement display 206 and “Width Strips” in the annunciator display 220.

The following formulas are used to calculate the border related functions: The border default value can be set by the user to have straight cuts or can be set by the user to have mitered cuts.

BorderLength(mitered)=2*TopLength+2*TopWidth+8*BorderWidth

BorderLength(Straight)=2*TopLength+2*TopWidth+4*(BorderWidth+Seam)

TotalBorderStrips=RoundUp(BorderLength/Fabric Width−2*Seam), 0)

TotalBorderYardage=TotalBorderStrips*(Border Width+2*Seam)

Depressing the [Quilt Ydg] key 116 again at step 440 causes the drop area or yardage to be displayed at step 442 by displaying “DROP” in the alpha-numeric display and the appropriate value in the numeric displays. Depressing the [Quilt Ydg] key 116 again at step 444 causes the number of drop strips to displayed at step 446 by displaying “DROP” in the alpha-numeric display, the appropriate value in the numeric displays and “Qty Strips” in the annunciator display 220. The next depression of the [Quilt Ydg] key 116 at step 448 causes the drop strip cut width to be displayed at step 45° by displaying “DROP” in the alpha-numeric display, the appropriate value in the numeric displays, “Cut” in the units measurement display and “Width Strips” in the annunciator display.

The following formulas are used to calculate the drop related functions:

TotalDropLength(mitered)=2*TopLength+TopWidth+8*BorderWidth+4*Drop Width

TotalDropLength(straight)=2*TopLength+TopWidth+8*BorderWidth+2*Drop Width+2*Seam

TotalDropStrips=RoundUp(TotalDropLength/(Fabric Width−2*Seam), 0)

TotalDropYardage=TotalDropStrips*(Drop Width+2*Seam)

The next depression of the [Quilt Ydg] key 116 at step 452 causes the binding yardage to be displayed at step 454 by displaying “BNDNG” in the alpha-numeric display and the appropriate value in the numeric displays.

Another depression of the [Quilt Ydg] key 116 at step 456 causes the binding number of strips to be displayed at step 458 by displaying “BNDNG” in the alpha-numeric display, the appropriate value in the numeric displays and “Qty Strips” in the annunciator display. Still another depression of the [Quilt Ydg] key 116 at step 460 causes the stored binding strip cut width to be displayed at step 462 by displaying “BNDNG” in the alpha-numeric display, “Cut” in the units measurement display, the appropriate value in the numeric displays and “Width” in the annunciator display.

The following formulas are used to calculate the binding related functions:

BindingLength=(Total Width+TotalLength)*2

BindingStrips=RoundUp(BindingLength+(Fabric Width−2*Seam), 0)

BindingYardage=BindingStrips*BindingWidth

Upon additional presses of the [Quilt Ydg] key 116 at step 464, the calculator returns to the beginning of the calculated and displayed quilt function results at step 422. Repeated presses of the [Quilt Ydg] key 116 cause the calculator to cycle through the previously displayed information in steps 422-464.

Diagonal Functions

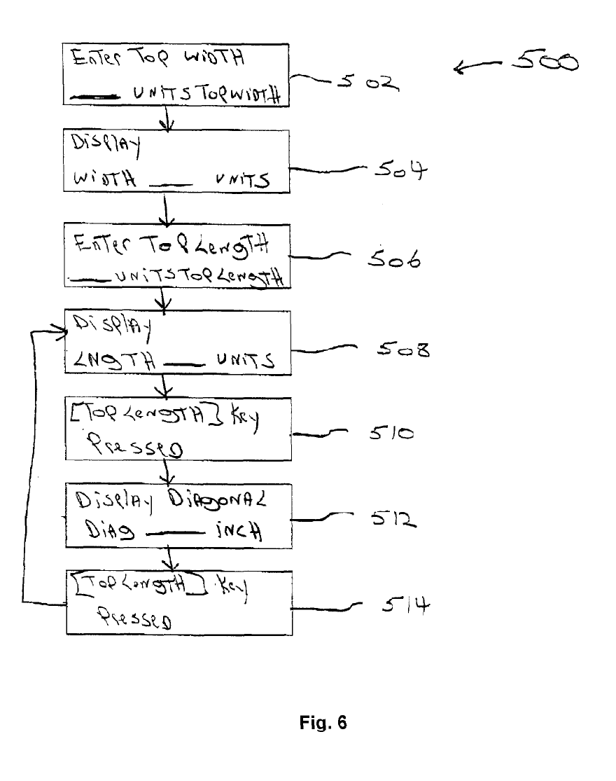

Referring to FIG. 6, a flowchart 500 that details the calculator operation and software program flow to determine and display quilt diagonal calculations is shown. First, a user enters a top width at step 502. inches is the default value for units. The default value can be also be set to other units such as meters. The display confirms the entered value at step 504 by displaying “WIDTH” in the alpha-numeric display 208 and the appropriate value in the numeric displays 202 and 204. The appropriate units are displayed on units measurement display 206. Next, the top length is entered at step 506. The display confirms the entered value at step 508 by displaying “LNGTH” in the alpha-numeric display and the appropriate value in the numeric displays. At step 510, the [Top Length] key 113 is pressed and the diagonal value calculated using the formula:

Diagonal=(TopLength²+TopWidth²)^{1/2}

The diagonal length is displayed at step 512 by displaying “DIAG” in the alpha-numeric display and the appropriate value in the numeric displays. Subsequent depression of the [Top Length] key 113 at step 514 causes the calculator to loop back to step 508 and to cycle through the previously displayed information in steps 508-514.

Block Functions

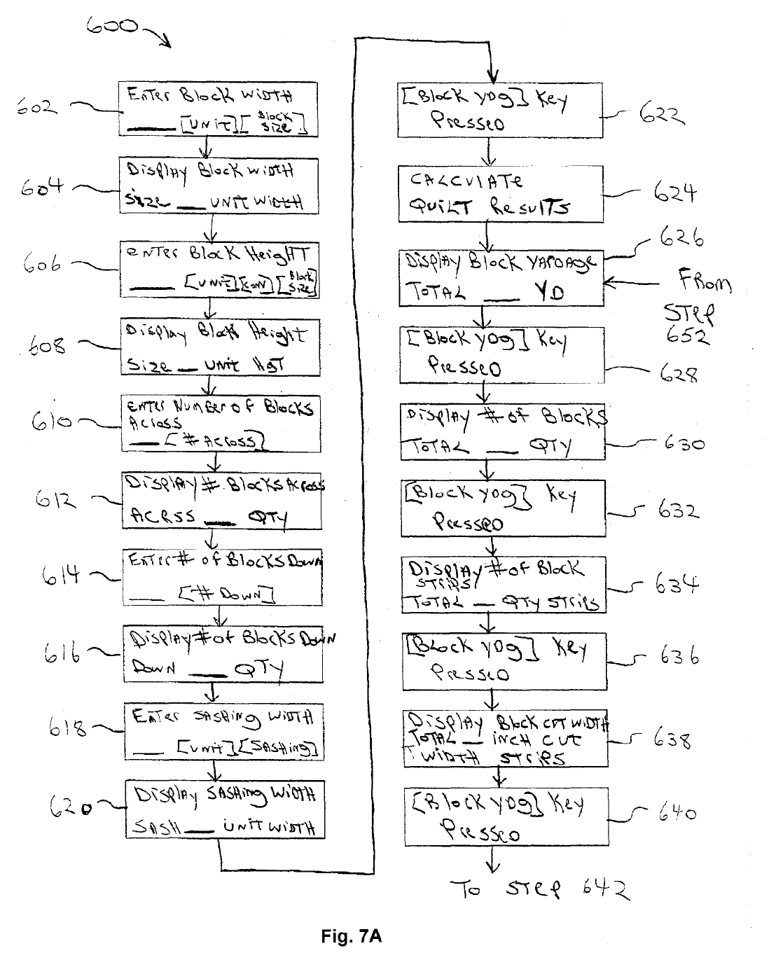

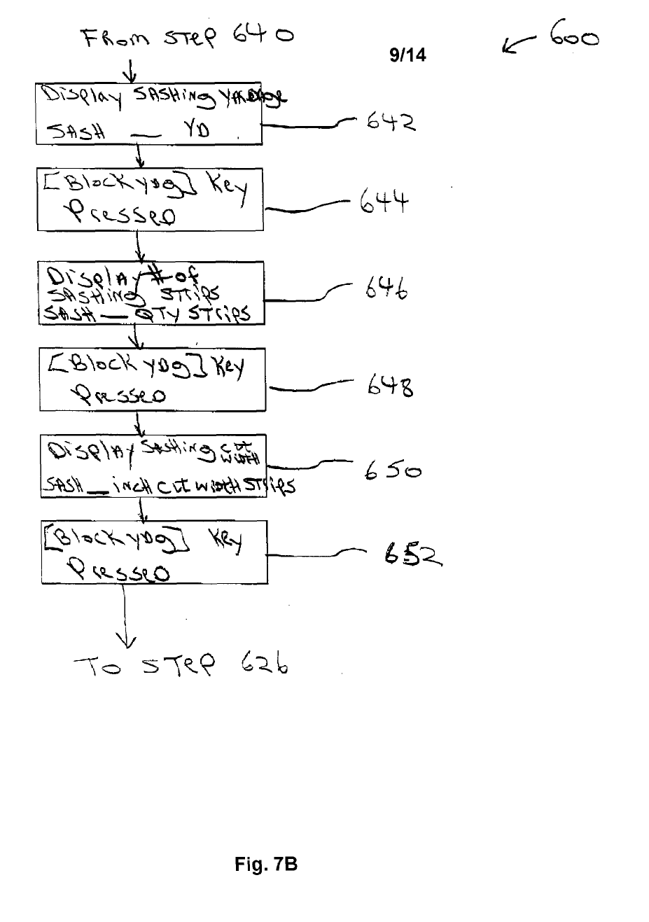

Referring to FIGS. 7A and 7B, a flowchart 600 that details the calculator operation and software program flow to determine and display block area and block calculations is shown. First, a user enters a block width at step 602. Inches is the default value for units. The default value can be set to other units such as meters. The display confirms the entered value at step 604 by displaying “SIZE” in the alpha-numeric display 208, the appropriate value in the numeric displays 202 and 204 and “Block” on the annuciator display 210. The appropriate units are displayed on units measurement display 206. Next, the block height is entered at step 606. The display confirms the entered value at step 608 by displaying “HGHT” in the alpha-numeric display, the appropriate value in the numeric displays and “13LOCK” in the annuciator display210. The number of blocks across is entered at step 610. The display confirms the entered value at step 612 by displaying “ACRSS” in the alpha-numeric display, the appropriate value in the numeric displays and “Qty” in the annunciator display. At step 614, the number of blocks down is entered. The display confirms the entered value at step 616 by displaying “DOWN” in the alpha-numeric display, the appropriate value in the numeric displays and “Qty” in the annunciator display. The sashing width is entered at step 618. The display confirms the entered value at step 620 by displaying “SASH” in the alpha-numeric display, the appropriate value in the numeric displays and “Width” on the annuciator display.

At step 622, the [Block Ydg] key 126 is depressed and all relevant calculations are performed at step 624. The block area or yardage is displayed at step 626 by displaying “TOTAL” in the alpha-numeric display and the appropriate value in the numeric displays. Subsequent depression of the [Block Ydg] key 126 at step 628 causes the number of blocks to be displayed at step 630 by displaying “TOTAL” in the alpha-numeric display, the appropriate value in the numeric displays and “Qty” on the annunicator display. Pressing the [Block Ydg] key 126 again at step 632 causes the number of block strips to be displayed at step 634 by displaying “TOTAL” in the alpha-numeric display, the appropriate value in the numeric displays and “Qty Strips” on the annunicator display.

Depressing the [Block Ydg] key 126 again at step 636 causes the block cut width to displayed at step 638 by displaying “TOTAL” in the alpha-numeric display, the appropriate value in the numeric displays, “Cut” in the units measurement display 206 and “Width Strips” in the annunciator display 220.

The following formulas are used to calculate the block related functions:

Strip Width=BlockWidth+2*Seam⁺

BlockStrips=Int(Yardage/StripWidth)−

BlocksPerStrip=Int(Fabric Width/(BlockHeight+2* Seam))⁻

TotalBlocks=BlocksAcross*BlocksDown

BlockStrips=RoundUp(TotalBlocks/BlocksPerStrip, 0)

TotalBlockYardage=BlockStrips*StripWidth

⁺ where the value is rounded to the nearest fraction for U.S. units and to the nearest 1/10 of a centimeter for metric units
where yardage is derived from the entered linear or area value
   {Results in a whole number}

Another depression of the [Block Ydg] key 126 at step 640 causes the sashing area or yardage to be displayed at step 642 by displaying “SASH” in the alpha-numeric display and the appropriate value in the numeric displays.

Pressing the [Block Ydg] key 126 again at step 644 causes the number of sashing strips to displayed at step 646 by displaying “SASH” in the alpha-numeric display, the appropriate value in the numeric displays and “Qty Strips” in the annunciator display 220. The next depression of the [Block Ydg] key 126 at step 648 causes the sashing strip cut width to be displayed at step 650 by displaying “SASH” in the alpha-numeric display, the appropriate value in the numeric displays, “Cut” in the units measurement display and “Width Strips” in the annunciator display.

The following formulas are used to calculate the sashing related functions:

InsideSashing=(BlocksAcross−1)*(BlocksDown*(BlockHeight+2*Seam))+(BlocksDown−1)*(BlocksAcross*(BlockWidth+2*Seam))+(BlocksAcross−1)*(BlocksDown−1)*SashingWidth⁺

OutsideSashing=2*(BlocksAcross*(BlockWidth+SashingWidth)+BlocksDown*(BlockHeight+SashingWidth)+2*if(Miter=True,SashingWidth,Seam))

Sashing Length=InsideSashing+(SashingBorder=True) (OutsideSashing)

SashingStrips=SashingLength÷(Fabric Width−2*Seam)

SashingYardage=RoundUp(SashingStrips)*SashingWidth

⁺IfBlocksAcross and BlocksDown=1, then InsideSashing=0

Upon additional presses of the [Block Ydg] key 126 at step 652, the calculator returns to the beginning of the calculated and displayed quilt function results at step 626. Repeated presses of the [Block Ydg] key 126 cause the calculator to cycle through the previously displayed information in steps 626-652.

Square Functions

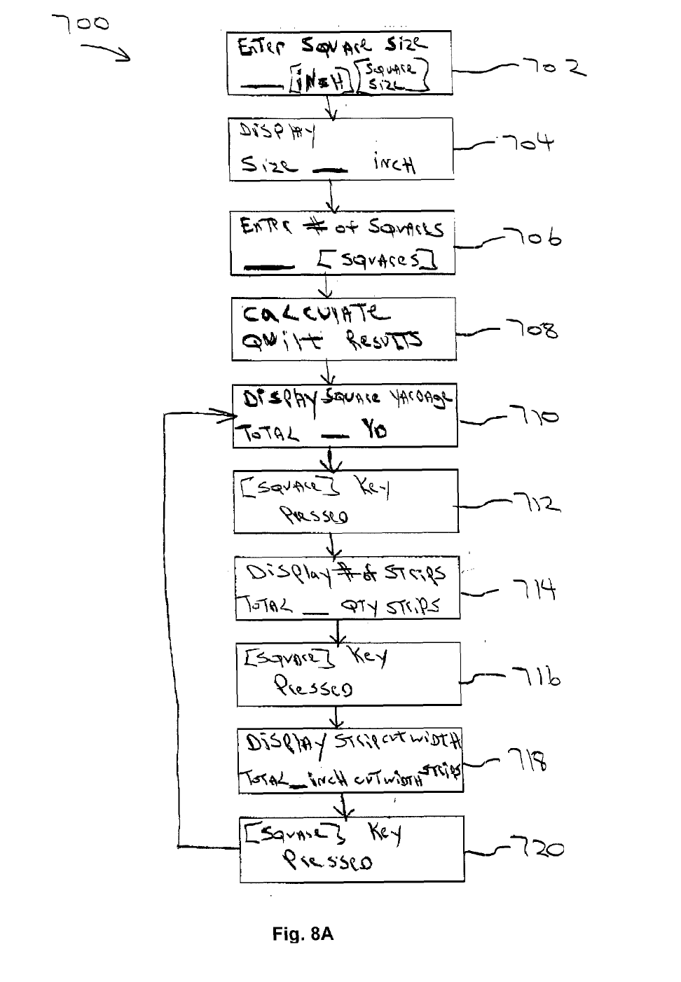

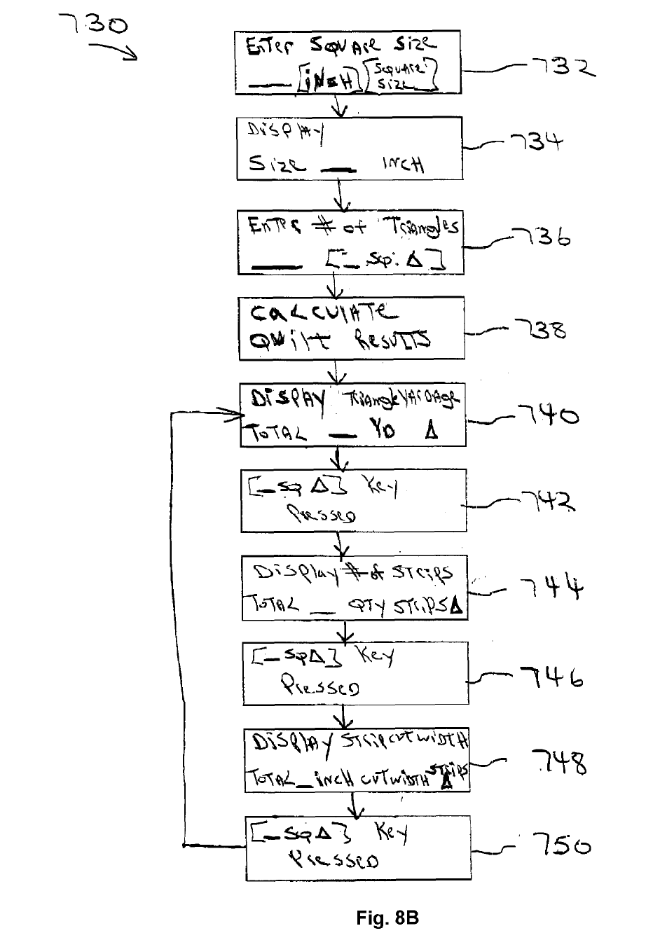

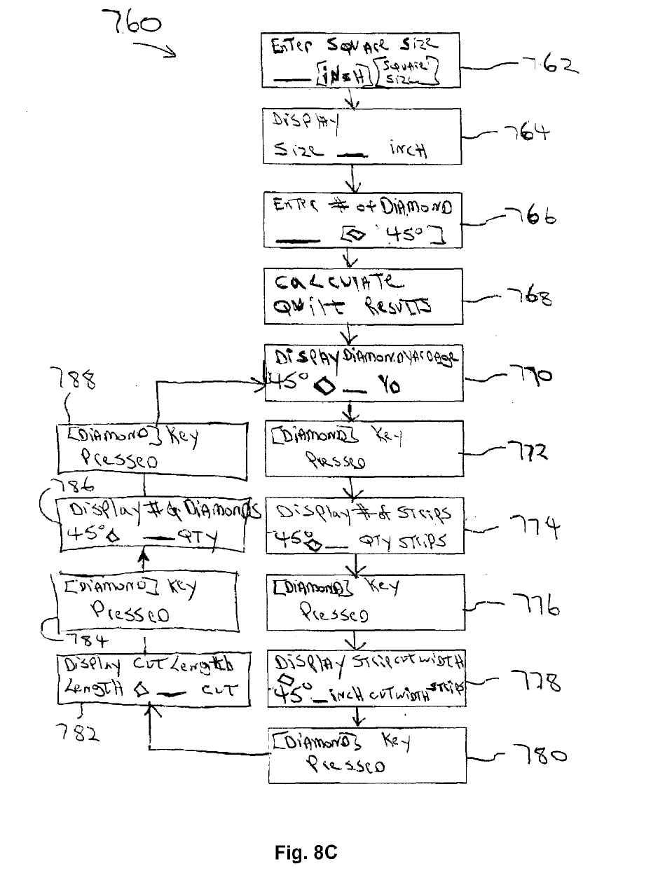

Referring to FIG. 8A, a flowchart 700 that details the calculator operation and software program flow to determine and display square area and square calculations is shown. First, a user enters a square size at step 702. Inches is the default value for units. The default value can be set to other units such as meters. The display confirms the entered value at step 704 by displaying “SIZE” in the alpha-numeric display 208 and the appropriate value in the numeric displays 202 and 204. The appropriate units are displayed on units measurement display 206. Next, the number of squares is entered at step 706.

At step 708, all relevant calculations are performed. The square area or yardage is displayed at step 710 by displaying “TOTAL” in the alpha-numeric display and the appropriate value in the numeric displays. Subsequent depression of the [Squares] key 133 at step 712 causes the number of square strips to be displayed at step 714 by displaying “TOTAL” in the alpha-numeric display, the appropriate value in the numeric displays and “Qty Strips” on the annunicator display. Pressing the [Squares] key 133 again at step 716 causes the square strip cut width to displayed at step 718 by displaying “TOTAL” in the alpha-numeric display, the appropriate value in the numeric displays, “Cut” in the units measurement display 206 and “Width Strips” in the annunciator display 220.

Upon additional presses of the [Squares] key 133 at step 720, the calculator returns to the beginning of the calculated and displayed quilt function results at step 710. Repeated presses of the [Squares] key 133 cause the calculator to cycle through the previously displayed information in steps 710-720.

Calculator 100 can also calculate square functions using length and area inputs instead of the number of squares.

The following formulas are used to calculate the square related functions:

SquareStrips=RoundUp(SquareQuantity/(Int(Fabric Width/SquareSize+2*Seam)), 0)

Square Yardage=SquareStrips*StripWidth

Strip Width=SquareSize+2*Seam⁺

BlockStrips=Int(Yardage/Strip Width)−

⁺ where the value is rounded to the nearest fraction for U.S. units and the nearest 1/10 of a centimeter for metric units
where yardage is derived from the entered linear of area value

½ and ¼ Square Triangle Functions

Referring to FIG. 8B, a flowchart 730 that details the calculator operation and software program flow to determine and display ½ or ¼ square triangle calculations is shown. First, a user enters a square size at step 732 using the square size key 132. Inches are the default value for units. The display confirms the entered value at step 734 by displaying “SIZE” in the alpha-numeric display 208 and the appropriate value in the numeric displays 202 and 204. The appropriate units are displayed on units measurement display 206. Next, the number of triangles is entered at step 736 using either the ½ square triangle key 134 or the ¼ triangle key 135 depending upon the desired triangle shape.

At step 738, all relevant calculations are performed. The triangle area or yardage is displayed at step 740 by displaying “HALF”or “QTR” in the alpha-numeric display, a triangle in triangle display 216 and the appropriate value in the numeric displays. Subsequent depression of either triangle key 134 or 135 at step 742 causes the number of triangle strips to be displayed at step 744 by displaying “HALF” or “QTR” in the alpha-numeric display, a triangle in triangle display 216, the appropriate value in the numeric displays and “Qty Strips” on the annunicator display. Pressing either triangle key 134 or 135 at step 746 causes the triangle strip cut width to displayed at step 748 by displaying “HALF” or “QTR” in the alpha-numeric display, a triangle in triangle display 216, the appropriate value in the numeric displays, “Cut” in the units measurement display 206 and “Width Strips” in the annunciator display 220.

Upon additional presses of either triangle key 134 or 135 at step 750, the calculator returns to the beginning of the calculated and displayed quilt function results at step 740. Repeated presses of either triangle key 134 or 135 causes the calculator to cycle through the previously displayed information in steps 740-750.

The following formulas are used to calculate the ½ square triangle related functions:

HalfTriangleStrips=RoundUp(HalfTriangleQuantity/2÷(Truncate(Fabric Width÷Strip Width), 0)

HalfTriangleYardage=HalfTriangleStrips*Strip Width

The following formulas are used to calculate the ¼ square triangle related functions:

Strip Width=SquareSize+Seam_{1/4}⁺

BlockStrips=Int(Yardage/StripWidth)−

QtrTriangleStrips=RoundUp(QtrTriangleQuantity/4÷(Truncate(Fabric Width÷Strip Width), 0)

QtrTriangle Yardage=QtrTriangleStrips*Strip Width

⁺ where the value is rounded to the nearest fraction for U.S. units and the nearest 1/10 centimeter for metric units

45° and 60° Diamonds Functions

Referring to FIG. 8C, a flowchart 760 that details the calculator operation and software program flow to determine and display 45° and 60° diamond calculations is shown. First, a user enters a square size at step 762 using the square size key 132. Inches are the default value for units. The display confirms the entered value at step 764 by displaying “SIZE” in the alpha-numeric display 208 and the appropriate value in the numeric displays 202 and 204. The appropriate units are displayed on units measurement display 206. Next, the number of diamonds is entered at step 766 using either the 45° or diamonds key 136 or the 60° diamonds key 137 depending upon the desired diamond shape.

At step 768, all relevant calculations are performed. The diamond area or yardage is displayed at step 770 by displaying “45°” or “60°” in the alpha-numeric display, a diamond in diamond display 214 and the appropriate value in the numeric displays. Subsequent depression of diamond key 136 or 137 at step 772 causes the number of diamond strips to be displayed at step 774 by displaying “45°” or “60°” in the alpha-numeric display, a diamond in diamond display 214, the appropriate value in the numeric displays and “Qty Strips” on the annunicator display. Pressing diamond key 136 or 137 at step 776 causes the diamond strip cut width to be displayed at step 778 by displaying “45°” or “60°” in the alpha-numeric display, a diamond in diamond display 214, the appropriate value in the numeric displays, “Cut” in the units measurement display 206 and “Width Strips” in the annunciator display 220.

Another press of diamond key 136 or 137 at step 780 causes the diamond cut length to be displayed at step 782 by displaying “LNGTH°” in the alpha-numeric display, a diamond in diamond display 214, the appropriate value in the numeric displays and “Cut” in the units measurement display 206. An additional use of diamond key 136 or 137 at step 784 causes the number of diamonds previously entered to be displayed at step 786 by displaying “45°” or “60°” in the alpha-numeric display, a diamond in diamond display 214 and the appropriate value in the numeric displays

Upon additional presses of either diamond key 136 or 137 at step 788, the calculator returns to the beginning of the calculated and displayed quilt function results at step 770. Repeated presses of either diamond key 136 or 137 causes the calculator to cycle through the previously displayed information in steps 770-786.

The following formulas are used to calculate the 45° diamond related functions:

DiamondStrip Width=SquareSize*sin(45°)+2*Seam⁺

DiamondCutLength=SquareSize+Seam_{45°}−

DiamondStrips=RoundUp(DiamondQuantity÷(Truncate(Fabric Width/DiamondCutLength−cos(45°)),0)

DiamondYardage=DiamondStrip Width*DiamondStrips

⁺where the value is rounded to the nearest fraction for U.S. units and the nearest 1/10 centimeter for metric units
− where the value is rounded to the nearest fraction for U.S. units and the nearest 1/10 centimeter for metric units

The following formulas are used to calculate the 60° diamond related functions:

DiamondStrip Width=SquareSize*sin(60°)+2*Seam⁺

DiamondCutLength=SquareSize+Seam_{60°}−

DiamondStrips=RoundUp(DiamondQuantity÷(Truncate(FabricWidth/DiamondCutLength−cos(60°)),0)

DiamondYardage=DiamondStrip Width*DiamondStrips

⁺ where the value is rounded to the nearest fraction for U.S. units and the nearest 1/10 centimeter for metric units
− where the value is rounded nearest fraction for U.S. units and the nearest 1/10 centimeter for metric units

Fabric Stash Functions

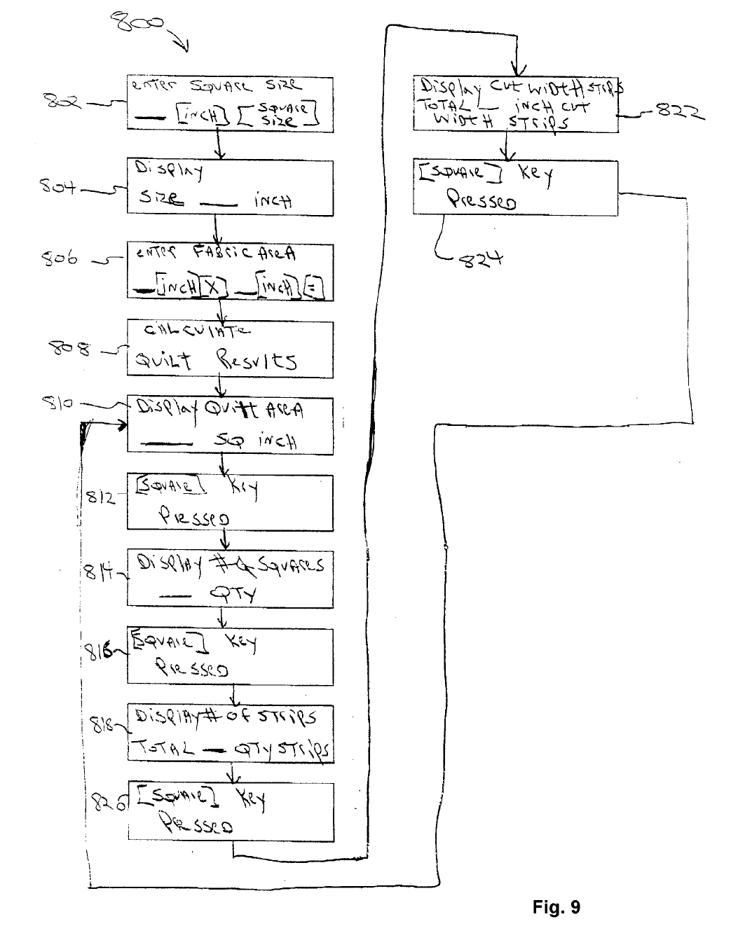

Referring to FIG. 9, a flowchart 800 that details the calculator operation and software program flow to determine the quilt size that can be made from a given quantity of fabric is shown. First, a user enters a desired square size at step 802. Inches are the default value for units. The default value can be set to other units such as meters. The display confirms the entered value at step 804 by displaying “SIZE” in the alpha-numeric display 208 and the appropriate value in the numeric displays 202 and 204. The appropriate units are displayed on units measurement display 206. Next, the known fabric size is entered at step 806 as length and width and the area calculated in step 808. The quilt area or yardage that can be made from the given fabric size is displayed at step 810 by displaying the appropriate value in the numeric displays and “Sq” and units on units measurement display 206.

Next, the [squares] key 133 is depressed at step 812 causing the display to show the number of squares that can be made at step 814 by displaying “TOTAL” in the alpha-numeric display, the appropriate value in the numeric displays, “Qty” in the units measurement display 206 and “Sq” in the annunciator display 220. When the squares key 133 is depressed again at step 816, the display shows the number of square strips The display shows “TOTAL” in the alpha-numeric display, the appropriate value in the numeric displays and “Qty Strips” on the annunicator display at step 818.

Pressing the squares key 133 again at step 820 causes the square strip cut width to displayed at step 822 by displaying “TOTAL” in the alpha-numeric display, the appropriate value in the numeric displays, “Cut” in the units measurement display 206 and “Width Strips” in the annunciator display 220.

Upon additional presses of the squares key 133 at step 824, the calculator returns to the beginning of the calculated and displayed quilt function results at step 810. Repeated presses of the squares key 133 causes the calculator to cycle through the previously displayed information in steps 810-824. The triangle and diamond keys have the same functionality of computing square quantities using an entered stash size or area.

Cost of Material Functions

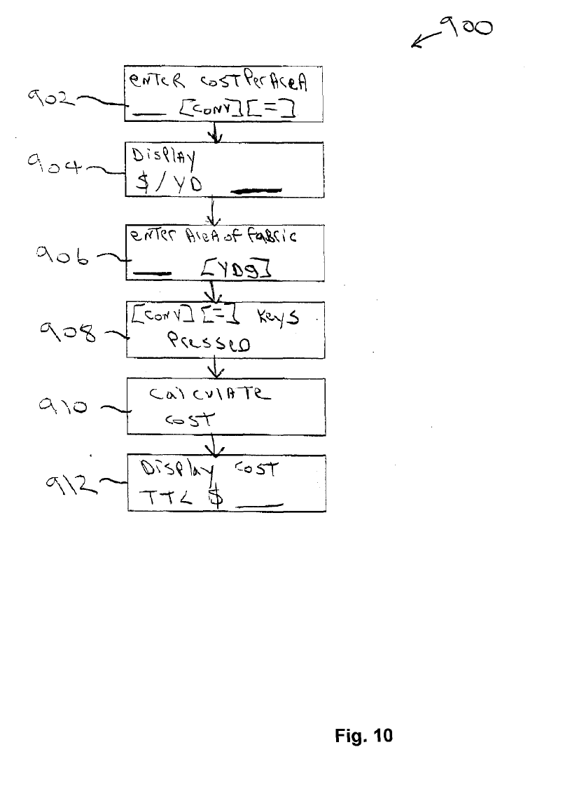

Referring to FIG. 10, a flowchart 900 that details the calculator operation and software program flow to determine the cost of an area of fabric or material is shown. First, a user enters a cost per unit area at step 902 using the [Conv] key 151 and the [=] key 186 in sequence. Cost per yard is the default setting. The default setting can also be set to cost per meter. The display confirms the entered value at step 904 by displaying “$/YD” in the alpha-numeric display 208 and the appropriate value in the numeric displays 202. The appropriate units are displayed on units measurement display 206.

Next, the length or area of fabric is entered at step 906, then [Conv] key 151 and the [=] key 186 are depressed in sequence at step 908. The cost is calculated at step 910 and at step 912 the cost is shown by displaying “TTL$” in the alpha-numeric display and the appropriate value in the numeric displays

It can be realized that certain embodiments of the present invention provide a calculator for performing quilt and fabric related calculations. The present invention also provides a method of storing and calculating quilt related data and functions.

It is noted that the calculator of the present invention is not limited for use in performing quilt related calculations. The calculator may also be used for performing calculations involving covering an area with a material. For example, the calculator can be used to calculate parameters related to carpets, drapery, clothing and flooring.

### CONCLUSION

It can thus be realized that certain embodiments of the present invention can provide a calculator for performing quilt and fabric related calculations.

Although the description above contains many specifications, these should not be construed as limiting the scope of the invention but as providing illustrations of some of present embodiments of this invention. Thus, the scope of the invention should be determined by the appended claims and their legal equivalents rather than by the examples given.

What is claimed is:

1. A calculator comprising:
(A) an input device configured to allow a user to input information;
(B) a display device configured to communicate information to the user; and
(C) a processor in communication with the input device and in communication with the display device, the processor being configured to:
(a) receive at least one quilt function operand from the input device;
(b) calculate at least one quilt function result; and
(c) display the quilt function result on the display device.

2. The calculator of claim 1 wherein the quilt function operands are chosen from the group consisting of:
(A) quilt width;
(B) quilt length;
(C) border width;
(D) block size;
(E) block orientation;
(F) seam width;
(G) binding cut width;
(H) fabric width;
(I) backing overage;
(J) drop width;
(K) block width;
(L) block height;
(M) number of width blocks;
(N) number of height blocks;
(O) sash width;
(P) square size;
(Q) number of squares;
(R) number of one-half triangles;
(S) number of one-fourth triangles;
(T) number of sixty degree diamonds; and
(U) number of forty five degree diamonds.

3. The calculator of claim 1 wherein the quilt function results are chosen from the group consisting of:
(A) quilt area;
(B) backing area;
(C) batting area;
(D) binding area;
(E) border area;
(F) drop area;
(G) number of border strips;
(H) number of binding strips;
(I) binding cut width;
(J) material costs;
(K) quilt diagonal length;
(L) sash area;
(M) number of sash strips;
(N) sash strip cut width;
(O) block area;
(P) number of blocks;
(Q) number of block strips;
(R) block strip cut width;
(S) sixty degree diamond area;
(T) sixty degree diamond strip cut width;
(U) sixty degree diamond strip cut length;
(V) forty five degree diamond area;
(W) forty five degree diamond strip cut width;
(X) forty five degree diamond strip cut length;
(Y) number of drop strips;
(Z) drop strip cut width;
(AA) border strip cut width;
(BB) block diagonal length;
(CC) square diagonal length;
(DD) square area;
(EE) one-half triangle area;
(FF) number of one-half triangle strips;
(GG) one-half triangle strip cut width;
(HH) one-fourth triangle area;
(TI) number of one-fourth triangle strips; and
(JJ) one-fourth triangle strip cut width.

4. The calculator of claim 1 wherein the display device is configured to display fractions.

5. The calculator of claim 1 wherein the input device is configured to receive fractions.

6. The calculator of claim 1 wherein the quilt function operands are received in a first measurement system and the quilt function results are displayed in a second measurement system.

7. The calculator of claim 1 wherein the input device includes at least one of the following keys:
(A) a top width key;
(B) a top length key;
(C) a border key;
(D) a block size key;
(E) a drop key;
(F) a number across key;
(G) a number down key,
(H) a sashing key;
(I) a square size key;
(J) a number of squares key;
(K) a number of one-half triangles key;
(L) a number of one-fourth triangles key;
(M) a number of forty five degree diamonds key; and
(N) a number of sixty degree diamonds key.

8. The calculator of claim 1 further comprising:
(A) receiving at least one fabric area value; and
(B) calculating at least one quilt function operand.

9. A calculator comprising:
(A) an input device;
(B) a display; and
(C) a processor connected to the input device and the display, the processor programmed to:
(a) receive at least one quilt function operand from the input device;
(b) calculate at least one quilt function result; and
(c) show the quilt function result on the display.

10. The calculator of claim 9 wherein the quilt function operands are chosen from the group consisting of:
(A) quilt width;
(B) quilt length;
(C) border width;
(D) block size;
(E) block orientation;
(F) seam width;
(G) binding cut width;
(H) fabric width;
(I) backing overage;
(J) drop width;
(K) block width;
(L) block height;
(M) number of width blocks;
(N) number of height blocks;
(O) sashing width;
(P) square size;
(Q) number of squares;
(R) number of one-half triangles;
(S) number of one-fourth triangles;
(T) number of sixty degree diamonds; and
(U) number of forty five degree diamonds.

11. The calculator of claim 9 wherein the quilt function results are chosen from the group consisting of:
(A) quilt area;
(B) backing area;
(C) batting area;
(D) binding area;
(E) border area;
(F) drop area;
(G) number of border strips;
(H) number of binding strips;
(I) binding cut width;
(J) material costs;
(K) quilt diagonal length;
(L) sash area;
(M) number of sash strips;
(N) sash strip cut width;
(O) block area;
(P) number of blocks;
(Q) number of block strips;
(R) block strip cut width;
(S) sixty degree diamond area;
(T) sixty degree diamond strip cut width;
(U) sixty degree diamond strip cut length;
(V) forty five degree diamond area;
(W) forty five degree diamond strip cut width;
(X) forty five degree diamond strip cut length;
(Y) number of drop strips;
(Z) drop strip cut width;
(AA) border strip cut width;
(BB) block diagonal length;
(CC) square diagonal length;
(DD) square area;
(EE) one-half triangle area;
(FF) number of one-half triangle strips;
(GG) one-half triangle strip cut width;
(HH) one-fourth triangle area;
(II) number of one-fourth triangle strips; and
(JJ) one-fourth triangle strip cut width.

12. The calculator of claim 9 wherein the input device includes at least one of the following keys:
(A) a top width key;
(B) a top length key;
(C) a border key;
(D) a block size key;
(E) a drop key;
(F) a number across key;
(G) a number down key;
(H) a sashing key;
(I) a square size key;
(J) a number of squares key;
(K) a number of one-half triangles key;
(L) a number of one-fourth triangles key;
(M) a number of forty five degree diamonds key; and
(N) a number of sixty degree diamonds key.

13. The calculator of claim 9 further comprising:
(A) receiving at least one fabric area value; and
(B) calculating at least one quilt function operand.

14. A calculator for performing calculations and conversions of data for quilting, comprising:
(A) means responsive to at least one user key for calculating data related to at least one quilt calculation; and
(B) means for displaying the results of the at least one quilt calculation.

15. The calculator of claim 14 wherein the means for calculating data allows for the calculation of at least a portion of the cost of the quilt.

16. The calculator of claim 14 wherein at least one fabric type yardage can be stored on the calculator.

17. The calculator of claim 14 wherein the means for calculating data allows for the calculation of the amount of each type of fabric required.

18. The calculator of claim 14 wherein at least a portion of the user keys are dedicated to quilt function operands.

19. The calculator of claim 14 wherein the calculator has dimensions less than 6 inches in length, 5 inches in width and 1 inch in height.

20. A method for performing calculations, but not all necessarily in the order shown, comprising:
(A) receiving data related to at least one sewing calculation;
(B) calculating results related to the at least one sewing calculation; and
(C) displaying the results related to the at least one sewing calculation.

21. The method of claim 20 further comprising:
(A) entering data using at least one quilt operand key.

22. The method of claim 20 further comprising:
(A) storing default data.

23. The method of claim 20 further comprising:
(A) creating a quilt design from the data.

24. The method of claim 20 further comprising:
(A) displaying results using at least one quilt operand key.

25. The calculator of claim 14 wherein the quilt calculation includes calculating the optimum number of fabric strips that can be produced from a known fabric area.

26. The calculator of claim 14 wherein the calculator can perform quilt calculations and conversion in both yardages and meterages.

27. The calculator of claim 14 wherein the calculator can receive a variable fabric width.

28. The calculator of claim 26 wherein the calculator rounds up values for yardages and meterages to the next one-eighth yard increment.

29. The calculator of claim 20 further comprising: storing a plurality of fabric yardages.
